(19) United States
(12) Patent Application Publication
(10) Pub. No.: US 2025/0254441 A1
(43) Pub. Date: Aug. 7, 2025

(54) PHOTOELECTRIC CONVERSION DEVICE AND APPARATUS

(71) Applicant: CANON KABUSHIKI KAISHA, TOKYO (JP)

(72) Inventors: MOMONOSUKE ODANI, KANAGAWA (JP); NORIYUKI SHIKINA, TOKYO (JP); KEISUKE TAKAHASHI, TOKYO (JP); HIROAKI TANIGUCHI, TOKYO (JP); TOMOYA KOKADO, KANAGAWA (JP)

(21) Appl. No.: 19/038,854

(22) Filed: Jan. 28, 2025

(30) Foreign Application Priority Data
Feb. 1, 2024 (JP) 2024-014305

(51) Int. Cl. H04N 25/633; H04N 25/618; H04N 25/628; H04N 25/779

(52) U.S. Cl. CPC H04N 25/633; H04N 25/618; H04N 25/628; H04N 25/779

(57) ABSTRACT

A photoelectric conversion device is provided. The photoelectric conversion device includes a plurality of pixels, and a correction unit configured to correct, in accordance with correction data, a black level of pixel signals output from the plurality of pixels. The correction unit is configured to: change a level of a selection signal from a first level to a second level if a state of a photoelectric conversion system where the photoelectric conversion device is arranged changes in one frame period during which signals for generating one image are obtained; and select a setting for generating the correction data from a plurality of settings in accordance with the level.

### BACKGROUND OF THE INVENTION

### Field of the Invention

The present invention relates to a photoelectric conversion device and an apparatus.

### Description of the Related Art

It is known that, in a photoelectric conversion device in which a plurality of pixels are arranged in a matrix, the black level of a signal is corrected using a correction value generated based on a signal output from a light shielded pixel arranged in a light shielded region. When reading out signals from a light receiving region for each pixel row, if a power supply voltage fluctuates due to the influence of noise or the like, noise in a row direction (horizontal stripe noise) may occur in an image obtained from the readout signals. Japanese Patent Laid-Open No. 2009-284358 describes that, in order to suppress horizontal stripe noise, an offset signal based on the signal read out from a light shielded pixel is separated into multiple frequency components, and the frequency components each multiplied with a corresponding coefficient are added together, thereby generating a correction signal.

### SUMMARY OF THE INVENTION

In order to perform the process described in Japanese Patent Laid-Open No. 2009-284358, the circuit scale of the photoelectric conversion device may become large.

Some embodiments of the present invention provide a technique advantageous in suppressing the circuit scale.

According to some embodiments, a photoelectric conversion device comprising a plurality of pixels, and a correction unit configured to correct, in accordance with correction data, a black level of pixel signals output from the plurality of pixels, wherein the correction unit is configured to: change a level of a selection signal from a first level to a second level if a state of a photoelectric conversion system where the photoelectric conversion device is arranged changes in one frame period during which signals for generating one image are obtained; and select a setting for generating the correction data from a plurality of settings in accordance with the level, is provided.

According to some other embodiments, a photoelectric conversion device comprising a plurality of pixels, and a signal processor configured to correct a black level of pixel signals output from the plurality of pixels in accordance with correction data, further comprising a detector configured to detect a fluctuation of a power supply voltage of the device and generate a selection signal, wherein if a fluctuation of the power supply voltage is detected, the detector changes a level of the selection signal from a first level to a second level, and the signal processor is configured to select a setting for generating the correction data from a plurality of settings in accordance with the level, is provided.

Further features of the present invention will become apparent from the following description of exemplary embodiments (with reference to the attached drawings).

### BRIEF DESCRIPTION OF THE DRAWINGS

FIG. 1 is a view showing an example of the arrangement of a photoelectric conversion device according to an embodiment;

FIG. 2 is a view showing an example of the arrangement of a photoelectric conversion portion of the photoelectric conversion device according to the embodiment;

FIG. 3 is a view showing an example of the arrangement of an AD conversion unit of the photoelectric conversion device according to the embodiment;

FIG. 4 is a timing chart showing the mechanism of occurrence of horizontal stripe noise during AD conversion in the photoelectric conversion device according to the embodiment;

FIG. 5 is a view showing an example of the arrangement of an OB clamp process unit of a correction unit of the photoelectric conversion device according to the embodiment;

FIG. 6 is a view showing an example of the arrangement of a correction value generation circuit of the OB clamp process unit according to the embodiment;

FIG. 7 is a block diagram showing an example of the arrangement of a detection unit of the photoelectric conversion device according to the embodiment;

FIG. 8 is a flowchart showing the signal processing of the photoelectric conversion device according to the embodiment;

FIG. 9 is a view showing an example of the arrangement of a detection unit of the photoelectric conversion device according to the embodiment;

FIG. 10 is a view showing an example of the arrangement of a pixel of the photoelectric conversion device according to the embodiment;

FIG. 11 is a view showing an example of the arrangement of the photoelectric conversion portion of the photoelectric conversion device according to the embodiment;

FIG. 12 is a view showing an example of the arrangement of the photoelectric conversion portion according to the embodiment;

FIGS. 13A and 13B are timing charts showing vertical scanning of the photoelectric conversion device according to the embodiment;

FIG. 14 is a view showing an example of the arrangement of the OB clamp process unit of the correction unit of the photoelectric conversion device according to the embodiment;

FIG. 15 is a view showing an example of the arrangement of a smear detection unit of the OB clamp process unit of the photoelectric conversion device according to the embodiment;

FIG. 16 is a flowchart showing the signal processing of the photoelectric conversion device according to the embodiment;

FIG. 17 is a view showing an example of the arrangement of the photoelectric conversion device according to the embodiment; and

FIG. 18 is a view showing an example of the arrangement of an apparatus incorporating the photoelectric conversion device according to the embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

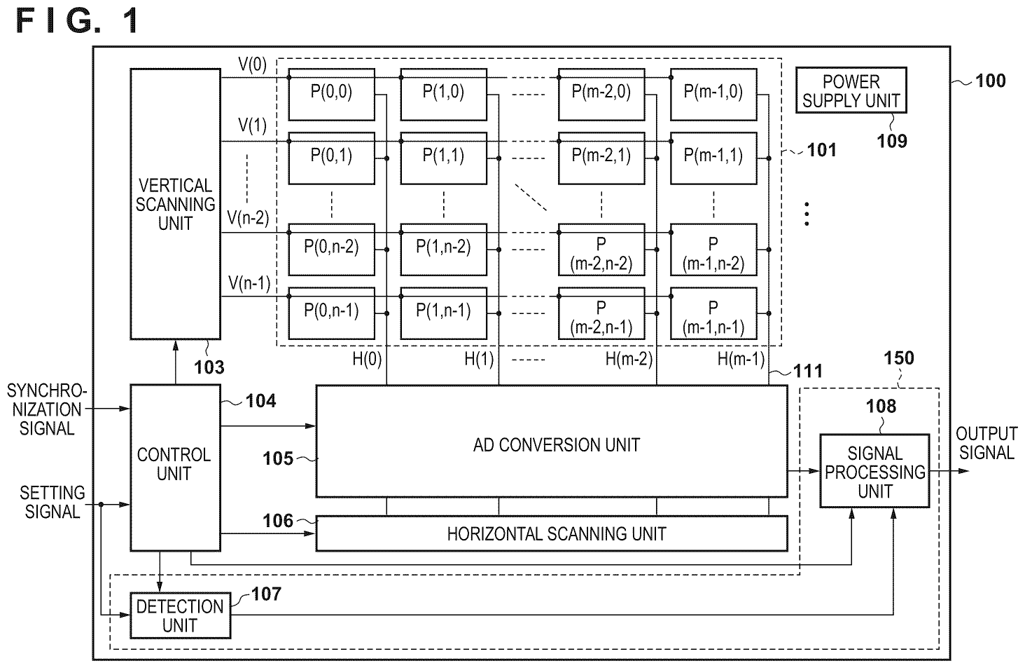

With reference to FIGS. 1 to 18, a photoelectric conversion device according to an embodiment of the present disclosure will be described. FIG. 1 is a view showing an example of the arrangement of a photoelectric conversion device 100 in the present disclosure. The photoelectric conversion device 100 includes a photoelectric conversion unit 101 where a plurality of pixels 102 are arranged, and a correction unit 150 that corrects, in accordance with correction data, the black level of pixel signals output from the plurality of pixels 102. The correction unit 150 includes a detection unit 107 and a signal processing unit 108. The photoelectric conversion unit 101 includes a light receiving region and a light shielded region to be described later, and outputs image data to be processed by the signal processing unit 108. The photoelectric conversion device 100 can further include a power supply unit 109 that supplies a power supply voltage to the entire device, a vertical scanning unit 103, a control unit 104, an AD conversion unit 105, and a horizontal scanning unit 106. In this embodiment, the correction unit 150 is arranged in the photoelectric conversion device 100. However, the present invention is not limited to this. For example, the signal processing unit 108 may be separated from the photoelectric conversion device 100. For example, the detection unit 107 may also be separated from the photoelectric conversion device 100. Furthermore, for example, the correction unit 150 including the detection unit 107 and the signal processing unit 108 may be separated from the photoelectric conversion device 100.

The photoelectric conversion unit 101 is formed from the (m)×(n) pixels including m pixels 102 in a row direction (the horizontal direction in FIG. 1) and n pixels 102 in a column direction (the vertical direction in FIG. 1). The vertical scanning unit 103 is connected to m pixels 102 via a row selection line 110 arranged to correspond to each row, and selects the pixel row to read out signals. In the selected pixel row, signals output from m pixels 102 included in the selected pixel row are collectively read out to the AD conversion unit 105 via vertical output lines 111.

A setting signal indicating the shooting conditions for shooting using the photoelectric conversion device 100 or the like is input to the control unit 104. The setting signal can be supplied from, for example, the control unit of a photoelectric conversion system where the photoelectric conversion device 100 is arranged. The control unit 104 supplies a control signal corresponding to the setting signal to each component included in the photoelectric conversion device 100. A synchronization signal is further input to the control unit 104. Based on the setting signal and the synchronization signal, the control unit 104 controls the operation timings of the vertical scanning unit 103, the AD conversion unit 105, the horizontal scanning unit 106, the detection unit 107, and the signal processing unit 108.

The AD conversion unit 105 converts (AD-converts) the signal output from the pixel 102 from an analog signal into a digital signal by, for example, slope AD conversion. The digital signal is read out to the signal processing unit 108 while referring to a signal form the horizontal scanning unit 106.

The detection unit 107 of the correction unit 150 generates a selection signal based on the setting signal. The selection signal is output to the signal processing unit 108 of the correction unit 150. The signal processing unit 108 performs a process of reducing reset noise generated by a switch element (for example, a MOS transistor) included in each pixel 102 in the photoelectric conversion unit 101. In addition, image data output from the photoelectric conversion unit 101 can include a dark current generated from a photodiode included in the pixel 102, and a variation (fixed pattern noise (FPN)) caused by a difference due to the circuit, such as a power supply impedance or a signal delay. In this specification, a state in which the FPN changes for each row and for each column with a certain rule is referred to as shading. The signal processing unit 108 reduces the reset noise component and then averages the light shielded data for each row and for each column, thereby generating correction data including an FPN component and a shading component. The signal processing unit 108 of the correction unit 150 can generate correction data by using an inter-pixel smoothing process or an inter-row smoothing process. Then, the signal processing unit 108 performs a process of correcting the variation for each column and a process of correcting the dark current component of the pixel.

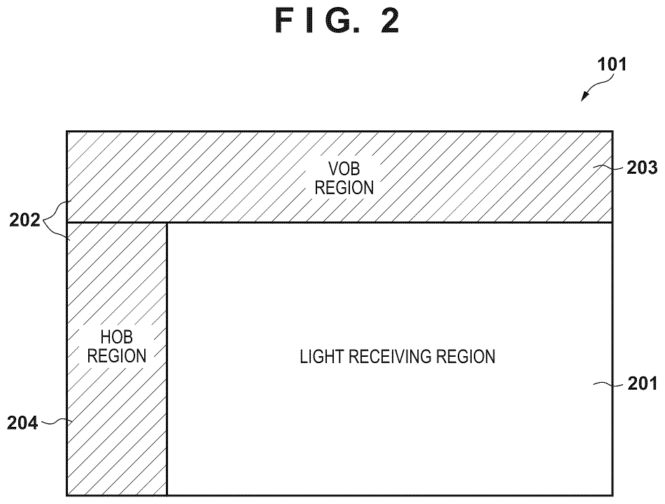

FIG. 2 is a conceptual diagram showing pixel signals output from the photoelectric conversion unit 101 while arranging them in accordance with the arrangement of the pixels 102 in the photoelectric conversion unit 101 in this embodiment. The photoelectric conversion unit 101 includes a light receiving region 201 where incident light having passed through an optical system such as a lens is received, and a light shielded region 202 optically shielded from incident light. The light shielded region 202 is a reference region for deciding the reference of a so-called black level in the pixel signal obtained by the photoelectric conversion unit 101. The signal processing unit 108 of the correction unit 150 generates correction data from the signal value based on the light shielded signal output from the pixel 102 arranged in the light shielded region 202 among the plurality of pixels 102. Here, as shown in FIG. 2, in the light shielded region 202, the region in the screen upper portion where the pixels 102 are optically shielded from light across the entire column is referred to as a VOB region 203. Further, the region located, for example, on the left side of the light receiving region 201 and where the pixels 102 are optically shielded from light across the entire row is referred to as an HOB region 204.

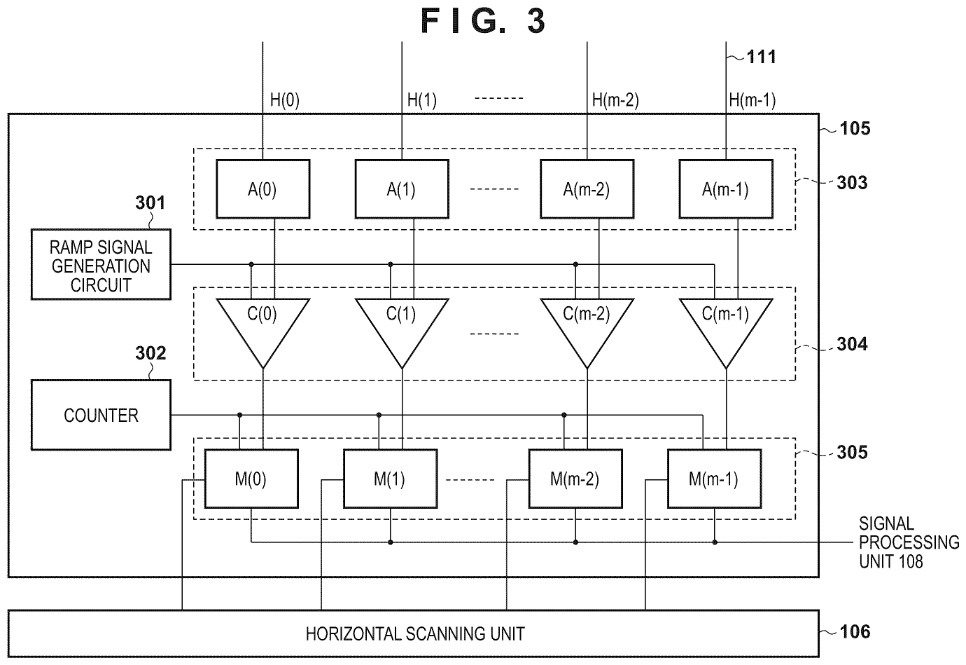

FIG. 3 is a block diagram of the AD conversion unit 105 in this embodiment. The AD conversion unit 105 includes a ramp signal generation circuit 301, a counter 302, a readout circuit 303, a comparison circuit 304, and a memory 305. The ramp signal generation circuit 301 generates a ramp signal, and supplies it to the comparison circuit 304. The counter 302 generates a count value, and supplies it to the memory 305. The readout circuit 303 may include an amplifier or the like and amplify the signal output from the pixel 102 via the vertical output line 111. The ramp signal and the pixel signal are input to the comparison circuit 304. If the voltage of the ramp signal exceeds the voltage of the pixel signal, the comparison circuit 304 outputs an inverted signal. A count value and the inverted signal are input to the memory 305. The memory 305 holds, as a digital signal in a storage element in the memory 305, the count value at the time of input of the inverted signal. The horizontal scanning unit 106 outputs the addressed digital signal to the signal processing unit 108.

When performing a process such as signal amplification or AD conversion on the analog signal in the AD conversion unit 105, horizontal stripe noise occurs due to a power supply fluctuation. This power supply fluctuation can occur due to an operation of a device (to be sometimes referred to as an external device hereinafter) other than the photoelectric conversion device, that constitutes the photoelectric conversion system where the photoelectric conversion device 100 is arranged. For example, assume that the control unit of the photoelectric conversion system performs an operation of supplying a setting signal to the photoelectric conversion device 100 in one frame period during which signals for generating one image are obtained. In this case, the circuit of the photoelectric conversion device 100 configured to hold the setting signal is activated, and a power supply fluctuation occurs due to coupling with the power supply voltage. In the image output from the photoelectric conversion device 100, horizontal stripe noise is superimposed on the row having undergone amplification or AD conversion in the period during which the setting signal has been written.

If the timing from reading out the pixel signal to storing it in the storage element is the same, in principle, the horizontal stripe noise has the same noise level in respective pixel signals. In general, the amount of horizontal stripe noise is small as compared to the random noise caused by the pixel 102. However, horizontal stripe noise is more visible than random noise, so that even a small amount of noise has a large influence on the image quality.

In this embodiment, as an example of a change of the state of the photoelectric conversion system such as the operation mode of an external device in one frame period, an example of a communication operation performed by the control unit of the photoelectric conversion system to write a setting signal in the photoelectric conversion device 100 has been described above. However, a change of the state of the photoelectric conversion system is not limited to this. Examples of a change of the state of the photoelectric conversion system include a communication operation performed by the photoelectric conversion device 100 to output image data to a recording unit of the photoelectric conversion system. Examples of a change of the state of the photoelectric conversion system also include an operation performed in a lens unit of the photoelectric conversion system to drive a motor for adjusting the lens position during autofocusing. In other words, examples of a change of the state of the photoelectric conversion system include communication between the photoelectric conversion device 100 and a device (external device) in the photoelectric conversion system other than the photoelectric conversion device, and driving of the motor of an external device.

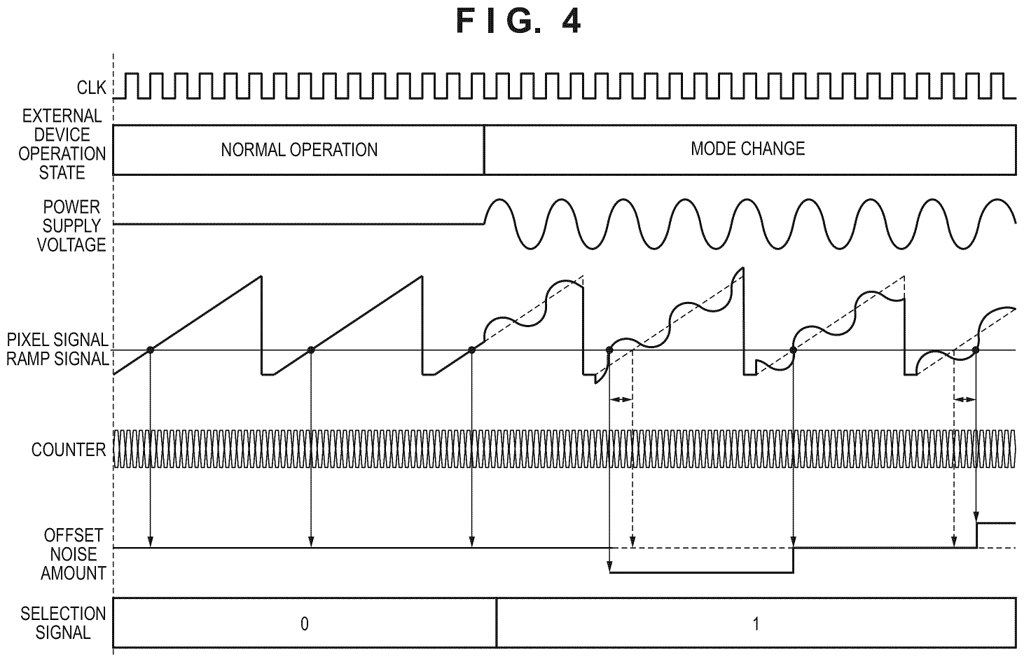

FIG. 4 is a timing chart showing the mechanism of occurrence of horizontal stripe noise during AD conversion. When the operation mode of the external device is a normal operation, the fluctuation of the power supply voltage supplied from the power supply unit 109 is small in the photoelectric conversion device 100, or the AD conversion process and the fluctuation of the power supply voltage are in a synchronization relationship. Therefore, horizontal stripe noise is unlikely to occur in image data output from the photoelectric conversion device 100. If the operation mode of the external device changes so that the state of the photoelectric conversion system changes, the power supply voltage fluctuates, jitter occurs in a clock signal CLK in the photoelectric conversion device 100, and the linearity characteristic of the ramp signal generated by the ramp signal generation circuit 301 deteriorates. Accordingly, the output timing of the inverted signal from the comparison circuit 304 shifts. As a result, offset noise is superimposed on the digital signal held by the memory 305.

Since the fluctuation of the power supply voltage in the photoelectric conversion device 100 caused by a change of the state of the photoelectric conversion system and the AD conversion are in an asynchronous relationship, offset noise of various levels occur for each AD conversion. Since pixel signals output from a given pixel row are AD-converted at the same timing, uniform offset noise is added to the given pixel row, and horizontal stripe noise appears in the image data output from the photoelectric conversion device 100.

Here, if the state of the photoelectric conversion system where the photoelectric conversion device 100 is arranged changes, the selection signal is changed from level 0 to level 1 as shown in FIG. 4. A signal indicating the change of the state of the photoelectric conversion system is supplied, as the setting signal, from the control circuit of the photoelectric conversion system to the detection unit 107 of the correction unit 150. With this, the detection unit 107 of the correction unit 150 detects the change of the state of the photoelectric conversion system such as the operation mode of an external device, and changes the level of the selection signal to be generated. As shown in FIG. 4, the detection unit 107 may set the level of the selection signal to level 1 throughout the detection period during which the detection unit 107 is detecting the change of the state of the photoelectric conversion system. As shown in FIG. 4, the detection unit 107 may change the level of the selection signal to be generated even if it detects a change of the state of the photoelectric conversion system during one frame period during which signals for generating one image are obtained. The selection signal is supplied to the signal processing unit 108 of the correction unit 150.

In this embodiment, as an example of the fluctuation of the power supply voltage, the power supply voltage fluctuates in a sine wave shape. However, the shape of the fluctuation of the power supply voltage is not limited to this. The fluctuation of the power supply voltage may not be periodic, and can be, for example, completely random noise.

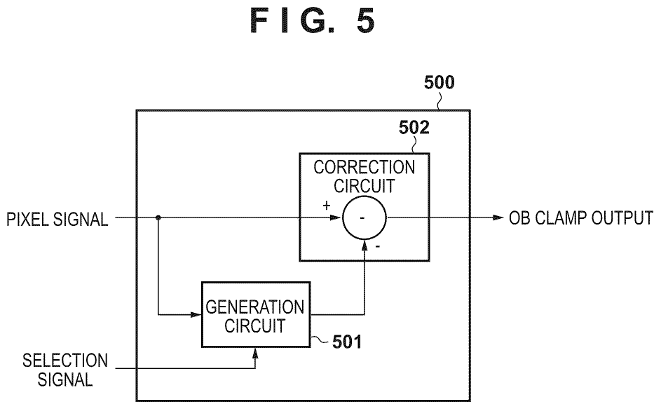

FIG. 5 is a block diagram of an OB clamp process unit 500 included in the signal processing unit 108 of the correction unit 150. The OB clamp process unit 500 includes a generation circuit 501 that generates correction data for correcting the black level of the pixel signal output from the pixel 102 arranged in the photoelectric conversion unit 101, and a correction circuit 502 that corrects the pixel signal in accordance with the correction data. It can also be said that the OB clamp process unit 500 corrects the dark current component of the pixel signal by using correction data generated from the signal value based on the light shielded signal output from the pixel 102 arranged in the light shielded region 202 among the plurality of pixels 102. This process is referred to as an OB clamp process.

The generation circuit 501 generates correction data from the signal value based on the light shielded signal by using the setting according to the selection signal supplied from the detection unit 107 described above. The correction circuit 502 subtracts the correction data generated by the generation circuit 501 from the pixel signal acquired by the pixel 102 arranged in the light receiving region 201, thereby correcting the pixel signal. Here, an arbitrary region in the light shielded region 202 can be set as the correction data acquisition region for each pixel row or each pixel column in the photoelectric conversion unit 101. The correction data generated from the light shielded signal is referred to as a clamp value.

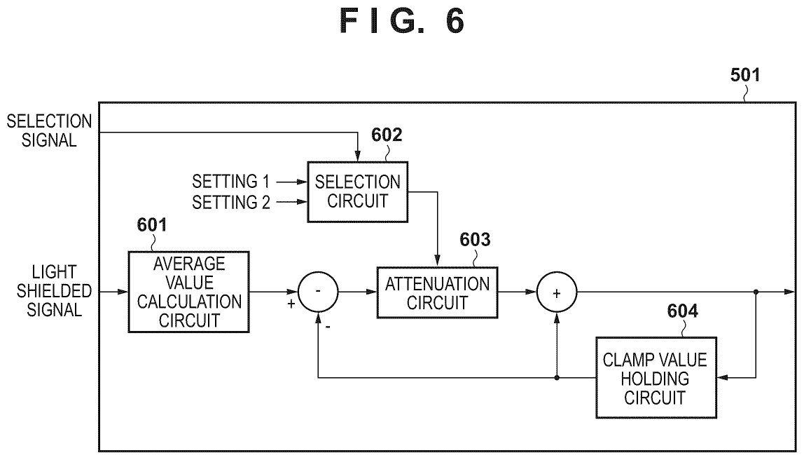

FIG. 6 is a block diagram of the generation circuit 501 that generates correction data (clamp value) in this embodiment. The generation circuit 501 includes an average value calculation circuit 601, a selection circuit 602, an attenuation circuit 603, and a clamp value holding circuit 604. In the generation circuit 501, the clamp value held by the clamp value holding circuit 604 is subtracted from the average value of the light shielded signals for, for example, each row calculated by the average value calculation circuit 601. By a filter process in which the subtraction result is attenuated by the attenuation circuit 603 using the setting such as a correction coefficient selected by the selection circuit 602 in accordance with the level of the selection signal, and the clamp value held by the clamp value holding circuit 604 is added to the attenuated value, a new clamp value is generated. The generated new clamp value is held by the clamp value holding circuit 604. It can also be said that generation circuit 501 is configured to select the setting for generating a clamp value (correction data) from a plurality of settings in accordance with the level of the selection signal supplied from the detection unit 107.

In this embodiment, in the filter process executed in the generation circuit 501, a clamp value is generated by filtering the light shielded signals for each row through an infinite impulse response-type low-pass filter (IIR-type LPF). From the viewpoint of reducing row variations, the filter process may use the IIR-type LPF as described above. However, the filter process is not limited to the IIR-type LPF, and may be, for example, integral averaging. It is sufficient that an average value based on light shielded signals can be acquired as a clamp value. Thus, the generation circuit 501 can generate correction data by using an inter-pixel smoothing process or an inter-row smoothing process.

The average value calculation circuit 601 calculates the average value of the light shielded signals by using the light shielded signals acquired from the pixels 102 arranged in the light shielded region 202. The selection signal supplied from the detection unit 107 is a signal that transmits, to the selection circuit 602, the change of the state of the photoelectric conversion system such as the change of the operation mode of an external device as described above. Based on the level of the selection signal, the selection circuit 602 selects one of a setting 1 and a setting 2. In the arrangement shown in FIGS. 3 and 4, if the level of the selection signal is level 0, the setting 1 is selected. If the level of the selection signal is level 1, the setting 2 is selected. The attenuation circuit 603 uses the correction coefficient corresponding to the setting selected by the selection circuit 602 to set the amount of attenuation of the IIR-type LPF connected to the input node of the signal value (average value) based on the light shielded values.

For example, assume that the correction coefficient to be set in the attenuation circuit 603 as the setting 1 sets the higher tracking ability of the IIR-type LPF than the correction coefficient to be set in the attenuation circuit 603 as the setting 2. In this case, the detection unit 107 may generate the selection signal such that a clamp value is normally generated using the setting 1 but a clamp value is generated using the setting 2 if a change of the state of the photoelectric conversion system such as the operation mode of an external device is detected. If the state of the photoelectric conversion system changes, the correction coefficient corresponding to the setting 2 for setting a higher tracking ability than usual is selected. With this, it is possible to further effectively correct horizontal stripe noise.

In the arrangement shown in FIGS. 3 and 4, the detection unit 107 outputs the selection signal that has two types of levels of level 0 and level 1, and the generation circuit 501 generates a clamp value using the setting selected from two types of settings based on the level of the selection signal. However, each of the selection signal and the setting for generating a clamp value is not limited to two types. For example, the detection unit 107 may generate selection signals of a plurality of levels in accordance with the change of the state of the photoelectric conversion system. In accordance with this, the generation circuit 501 may generate a clamp value using the setting selected from three or more types of settings.

For example, if the photoelectric conversion system is in a predetermined state, the detection unit 107 may keep the level of the selection signal at level 0 regardless of a change of the state of the photoelectric conversion system. That is, if the state of the photoelectric conversion system is a predetermined state, the selection circuit 602 of the generation circuit 501 may generate a clamp value without switching the setting from the setting 1 regardless of a change of the state of the photoelectric conversion system. In this case, a signal indicating that the state of the photoelectric conversion system is a predetermined state may be directly supplied to the selection circuit 602.

For example, when the setting such as the correction coefficient is switched, a type of noise other than horizontal stripe noise can occur under a certain shooting condition. If it is considered that the generated noise becomes more dominant than horizontal stripe noise, deterioration of the obtained image quality can be suppressed by operating the attenuation circuit 603 without switching the setting. For example, in high-sensitivity shooting, random noise is large. Accordingly, by switching to the setting 2 for a high tracking ability, random noise can increase. If the random noise component is greater than the horizontal stripe noise component, reducing the random noise (not increasing the random noise) is prioritized over correcting the horizontal stripe noise, and the detection unit 107 keeps the level of the selection signal at level 0. On the other hand, in low-sensitivity shooting, random noise is small. Accordingly, even if the setting is switched to the setting 2 for a high tracking ability, an increase of the random noise is limited. In this case, it is regarded that the random noise component is smaller than the horizontal stripe noise component, and correcting the horizontal stripe noise is prioritized. If a change of the state of the photoelectric conversion system is detected as described above, the detection unit 107 switches the level of the selection signal from level 0 to level 1. For example, information of the sensitivity at the time of shooting is supplied as a setting signal supplied to the detection unit 107. In a state in which the sensitivity of the photoelectric conversion system is set to a predetermined sensitivity or higher, the detection unit 107 may keep the level of the selection signal at level 0 regardless of a change of the state of the photoelectric conversion system.

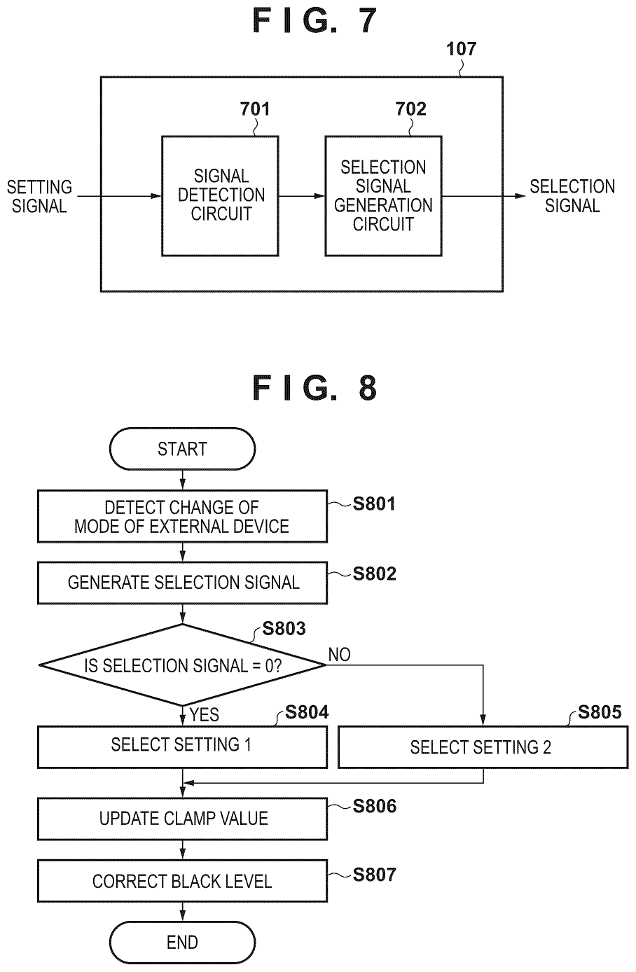

FIG. 7 is a block diagram of the detection unit 107 in this embodiment. The detection unit 107 includes a signal detection circuit 701 and a selection signal generation circuit 702. The signal detection circuit 701 refers to, for example, a setting signal supplied from the control unit of the photoelectric conversion system and, if a change of the setting signal is detected, determines that the state of the photoelectric conversion system such as the operation mode of an external device has changed. In this case, the selection signal generation circuit 702 changes the level of the selection signal from level 0 to level 1 and supplies the selection signal to the generation circuit 501. In this embodiment, the detection unit 107 is described as a component of the photoelectric conversion device 100, but the detection unit 107 may be arranged outside the photoelectric conversion device 100 as described above as long as it can refer to the setting signal and generate the selection signal.

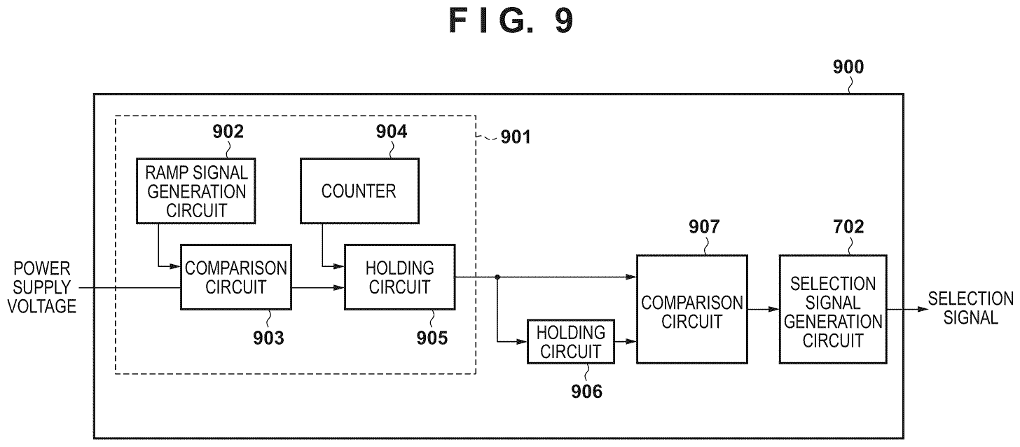

FIG. 8 is a flowchart showing signal processing in the correction unit 150 (the detection unit 107 and the OB clamp process unit 500 arranged in the signal processing unit 108). The correction unit 150 corrects horizontal stripe noise by using steps S801 to S807 shown in FIG. 8.

First, in step S801, a change of the state of the photoelectric conversion system such as a change of the mode of an external device is detected. By referring to the supplied setting signal as described above, if a communication operation or driving of the motor of an external device is performed, a change of the state of the photoelectric conversion system is detected.

Then, in step S802, a selection signal is generated. The selection signal generation circuit 702 of the detection unit 107 generates a signal at level 0 as the selection signal if the external device is in normal operation, and generates a signal at level 1 as the selection signal if a change of the state of the photoelectric conversion system is detected. For example, the selection signal generation circuit 702 may supply a signal at a ground level (no voltage application) as the signal at level 0 in a normal operation. If a change of the state of the photoelectric conversion system is detected, the selection signal generation circuit 702 may apply a predetermined voltage to a signal line to which the selection signal is supplied as the signal at level 1. The generated selection signal is supplied to the generation circuit 501 of the OB clamp process unit 500.

In step S803, the selection circuit 602 of the generation circuit 501 determines the level of the selection signal. If the selection signal is at level 0 (YES), the process transitions to step S804, and the correction coefficient corresponding to the setting 1 is set in the attenuation circuit 603. If the selection signal is not at level 0 (NO), the process transitions to step S805, and the correction coefficient corresponding to the setting 2 is set in the attenuation circuit 603.

Then, in step S806, a clamp value is updated as described above by the IIR-type LPF forming the generation circuit 501. In step S807, the correction circuit 502 corrects, using the updated clamp value, the black level of the pixel signal acquired in the photoelectric conversion unit 101.

With the operation as described above, horizontal stripe noise occurring in one frame period, during which signals are read out from the pixels 102 arranged in the light receiving region 201, can be corrected with almost no delay. In this embodiment, a change of the state of the photoelectric conversion system where the photoelectric conversion device 100 is arranged is detected using the setting signal, and the setting for generating the clamp value is switched. Accordingly, many calculations are not required, so that the circuit scale of each of the generation circuit 501 and the selection signal generation circuit 702 can be small. That is, it is possible to improve the quality of an obtained image while suppressing the circuit scale.

Furthermore, in this embodiment, a case has been described in which there are two levels of selection signals and two types of settings for generating the clamp value. However, as described above, the correction unit 150 may generate three or more levels of selection signals, and three or more types of settings for generating a clamp value. In this embodiment, a case is shown in which the setting for generating a clamp value is switched only once in one frame period. However, the present invention is not limited to this. Every time the state of the photoelectric conversion system changes, the level of the selection signal may be switched in accordance with the change, and the setting for generating a clamp value may be switched in accordance with the level of the selection signal.

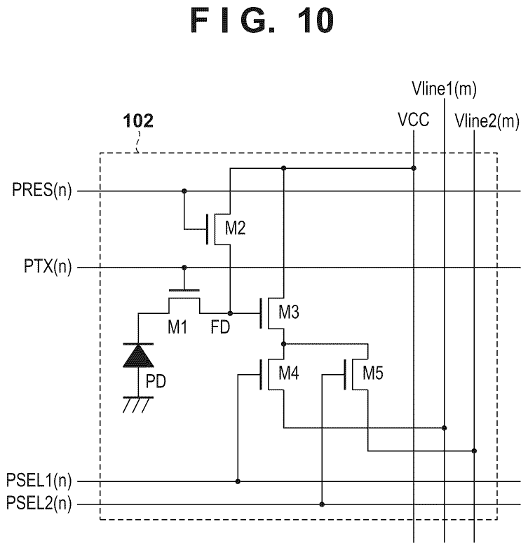

FIG. 9 is a view showing a modification of the detection unit 107 described above. It has been described that the detection unit 107 described above detects a change of the state of the photoelectric conversion system based on the setting signal, and changes the setting for generating a clamp value. However, the setting for generating a clamp value is changed not only when the state of the photoelectric conversion system where the photoelectric conversion device 100 is arranged changes. For example, when the power supply voltage in the photoelectric conversion device 100 supplied from the power supply unit 109 fluctuates, the level of the selection signal may be changed to change the setting for generating a clamp value. A detection unit 900 shown in FIG. 9 detects the fluctuation of the power supply voltage, and generates a selection signal. Differences from the above-described arrangement will be mainly described below, and the arrangement that may be similar to the above-described arrangement will not be described, as appropriate.

FIG. 9 is a block diagram of the detection unit 900. The detection unit 900 includes an AD conversion unit 901, a holding circuit 906, and a comparison circuit 907, in place of the signal detection circuit arranged in the detection unit 107. In the detection unit 900, the AD conversion unit 901 AD-converts the power supply voltage, and the holding circuit 906 holds the AD-converted signal. Then, the AD-converted signal and the preceding AD-converted signal held by the holding circuit 906 are input to the comparison circuit 907 to determine the presence/absence of the fluctuation of the power supply voltage. The determination result is supplied to the selection signal generation circuit 702. The selection signal generation circuit 702 outputs the selection signal at a level corresponding to the determination result to the signal processing unit 108.

The AD conversion unit 901 includes a ramp signal generation circuit 902, a comparison circuit 903, a counter 904, and a holding circuit 905. The AD conversion unit 901 converts the power supply voltage from an analog signal into a digital signal by using, for example, slope AD conversion. The ramp signal generation circuit 902 and the counter 904 perform operations similar to those of the above-described ramp signal generation circuit 301 and counter 302, respectively. The ramp signal and the power supply voltage are input to the comparison circuit 903. If the voltage of the ramp signal exceeds the power supply voltage, the comparison circuit 903 outputs an inverted signal. A count value and the inverted signal are input to the holding circuit 905. The holding circuit 905 holds, as a digital signal, the count value at the time of input of the inverted signal.

The holding circuit 906 holds the AD-converted count value. In synchronization with the timing of output of the next AD-converted count value from the AD conversion unit 901, the holding circuit 906 outputs the held count value to the comparison circuit 907. The comparison circuit 907 compares the count value output from the AD conversion unit 901 with the count value output from the holding circuit 906 to detect the fluctuation of the power supply voltage. That is, if the cyclic change of the value obtained by AD-converting the power supply voltage at a predetermined cycle exceeds a predetermined threshold, the detection unit 900 detects the fluctuation of the power supply voltage.

If the fluctuation of the power supply voltage of the photoelectric conversion device is detected, the selection signal generation circuit 702 changes the level of the selection signal from level 0 to level 1. The configuration of the selection signal output from the selection signal generation circuit 702 may be similar to the configuration of the selection signal output from the selection signal generation circuit 702 arranged in the detection unit 107 described above, and individual descriptions thereof will be omitted. The selection signal is supplied to the generation circuit 501, and the setting for generating a clamp value in the generation circuit 501 is changed in accordance with the selection signal.

The detection unit 900 may be additionally arranged in the photoelectric conversion device 100 shown in FIG. 1. In this case, the setting for generating a clamp value is changed in accordance with a change of the state of the photoelectric conversion system where the photoelectric conversion device 100 is arranged, and a change of the power supply voltage in the photoelectric conversion device 100. Even if the detection unit 900 is additionally arranged, the circuit configuration of the detection unit 900 is relatively small. Alternatively, the detection unit 900 may be arranged in the photoelectric conversion device 100 in place of the detection unit 107. The detection unit 900 is a component of the correction unit 150 described above.

In this embodiment, the AD conversion unit 901 AD-converts the power supply voltage using slope AD conversion, but the present invention is not limited to this. For example, the AD conversion unit 901 may perform AD conversion using another method such as successive-approximation A/D conversion or ΔΣ AD conversion.

In this embodiment, the AD conversion unit 105 that AD-converts the pixel signal and the AD conversion unit 901 that AD-converts the power supply voltage are shown as separate components, but the present invention is not limited to this. For example, the AD conversion unit 105 may include the AD conversion unit 901 of the detection unit 900, and the ramp signal generation circuit and the counter may be shared. With this arrangement, it is possible to further suppress the increase of the circuit scale caused by arranging the detection unit 900.

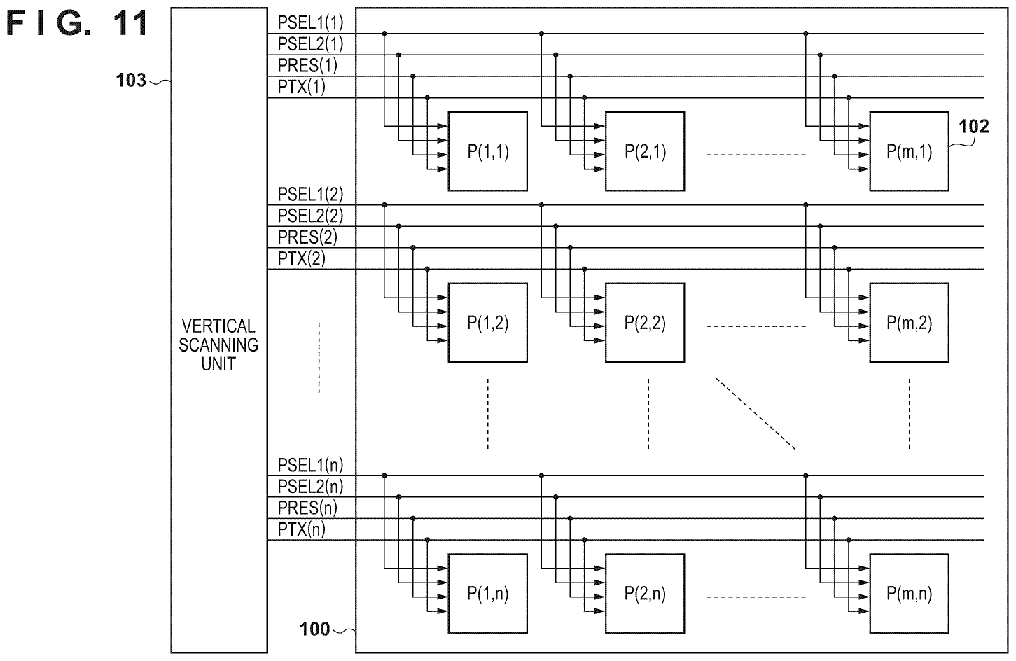

A further modification of the above-described photoelectric conversion device 100 will be described with reference to FIGS. 10 to 16. In addition to the horizontal stripe noise correction function described above, the photoelectric conversion device 100 according to this embodiment has a function of correcting a step caused by pixel control, and a function of correcting horizontal smear that occurs when strong light enters the photoelectric conversion unit 101. Differences from the above-described arrangement will be mainly described below, and the arrangement that may be similar to the above-described arrangement will not be described, as appropriate. For example, the photoelectric conversion device 100 in this embodiment can have the arrangement shown in FIG. 1, and the photoelectric conversion unit 101 can have the arrangement shown in FIG. 2.

Next, driving of the pixel 102 using the vertical scanning unit 103 in this embodiment will be described. The vertical scanning unit 103 is a driving circuit for driving the plurality of pixels 102 arranged in the photoelectric conversion unit 101.

The vertical scanning unit 103 performs readout scanning and electron shutter scanning of the photoelectric conversion unit 101 in accordance with control signals supplied from the control unit 104. The electron shutter scanning is an operation of sequentially releasing the reset states of photoelectric conversion elements of the pixels 102 arranged in some or all pixel rows of the photoelectric conversion unit 101 to set the photoelectric conversion elements in a charge accumulation state, thereby starting exposure. The readout scanning is an operation of sequentially causing the pixels 102 arranged in some or all pixel rows of the photoelectric conversion unit 101 to output signals based on the charges accumulated in the photoelectric conversion elements. The electron shutter scanning and the readout scanning are collectively referred to as pixel control hereinafter.

FIG. 10 shows an example of the arrangement of the pixel 102 arranged in the photoelectric conversion unit 101 in this embodiment. A description will be given assuming that the pixel 102 shown in FIG. 10 is a pixel arranged in the mth column and the nth row. The pixel 102 includes a photoelectric conversion element PD, a floating diffusion (to be sometimes simply referred as a “FD”), a transfer transistor M1, a reset transistor M2, an amplification transistor M3, a selection transistor M4, and a selection transistor M5.

The photoelectric conversion element PD is an element that performs photoelectric conversion to generate and accumulate charges corresponding to incident light. The photoelectric conversion element PD is, for example, a photodiode. The transfer transistor M1 transfers the charges accumulated in the photoelectric conversion element PD to the FD serving as the input node of the amplification transistor M3. The FD holds the charges transferred via the transfer transistor M1. The reset transistor M2 resets the voltage of the FD to a predetermined voltage. The amplification transistor M3 outputs a signal based on the potential of the FD, which fluctuates in accordance with the transferred charges, to a vertical output lines Vline1(m) or Vline2(m) in the mth column via the selection transistor M4 or the selection transistor M5, respectively.

The drains of the reset transistor M2 and the drain of the amplification transistor M3 are electrically connected to a power supply line VCC. The source of the amplification transistor M3 is electrically connected to the power supply unit 109 via the selection transistors M4 and M5 and the vertical output lines Vline1(m) and Vline2(m), thereby functioning as a source follower circuit. That is, the amplification transistor M3 can output a signal corresponding to the potential of the FD connected to the gate terminal.

Each transistor arranged in the pixel 102 may be formed from an n-channel transistor as shown in FIG. 10. However, the present invention is not limited to this, and each transistor arranged in the pixel 102 may be formed from a p-channel transistor.

A signal PTX(n) is a signal for controlling the transfer transistor M1 in the nth row, and is input to the gate of the transfer transistor M1. A signal PRES(n) is a signal for controlling the reset transistor M2 in the nth row, and is input to the gate of the reset transistor M2. A signal PSEL1(n) is a signal for controlling the selection transistor M4 in the nth row, and is input to the gate of the selection transistor M4. A signal PSEL2(n) is a signal for controlling the selection transistor M5 in the nth row, and is input to the gate of the selection transistor M5. Each transistor is set in a conductive state if the signal input to the gate is at high level, and set in a non-conductive state if the signal input to the gate is at low level.

When reading out a pixel signal from the pixel 102, for example, S (signal) data is read out after N (noise) data is read out. N data is obtained by releasing the reset of the FD and then reading out the charges in the FD via the amplification transistor M3 by controlling the gate voltage of the selection transistor M4 or the selection transistor M5. At this time, for readout from the selection transistor M4, the gate voltage of the selection transistor M4 is set at high level. For readout from the selection transistor M5, the gate voltage of the selection transistor M5 is set at high level. S data is obtained by, after reading out N data, transferring the charges in the photoelectric conversion element PD to the FD by the transfer transistor M1, and reading out the charges in the FD at that time via the amplification transistor M3 by controlling the gate voltage of the selection transistor M4 or the selection transistor M5. At this time, for readout from the selection transistor M4, the gate voltage of the selection transistor M4 is set at high level. For readout from the selection transistor M5, the gate voltage of the selection transistor M5 is set at high level.

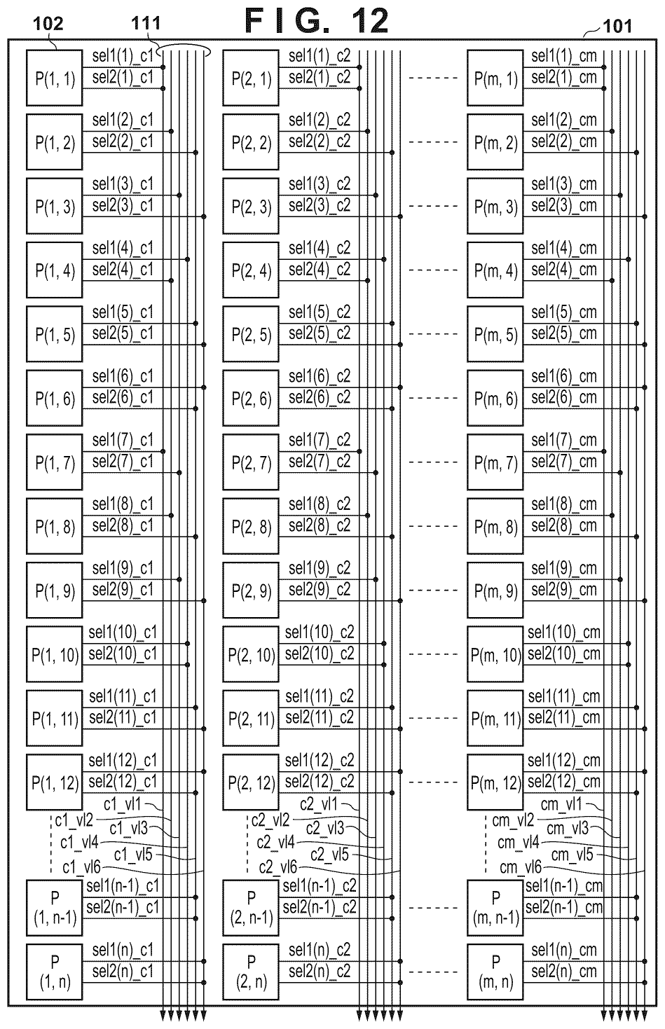

FIG. 11 is a schematic view showing an example of the arrangement of the vertical scanning unit 103 and the photoelectric conversion unit 101 in this embodiment. The vertical scanning unit 103 outputs signals PTX(#), PRES(#), PSEL1(#), and PSEL2(#) (#=1 to n). The signals PTX(k), PRES(k), PSEL1(k), and PSEL2(k) output from the vertical scanning unit 103 are supplied to the pixel 102(p(m, k)) (k=1 to n) arranged in the kth row. The vertical scanning unit 103 executes electron shutter scanning and readout scanning of the pixels 102 arranged in the Nth row (N is a natural number) by controlling the signals PTX(N), PRES(N), PSEL1(N), and PSEL2(N).

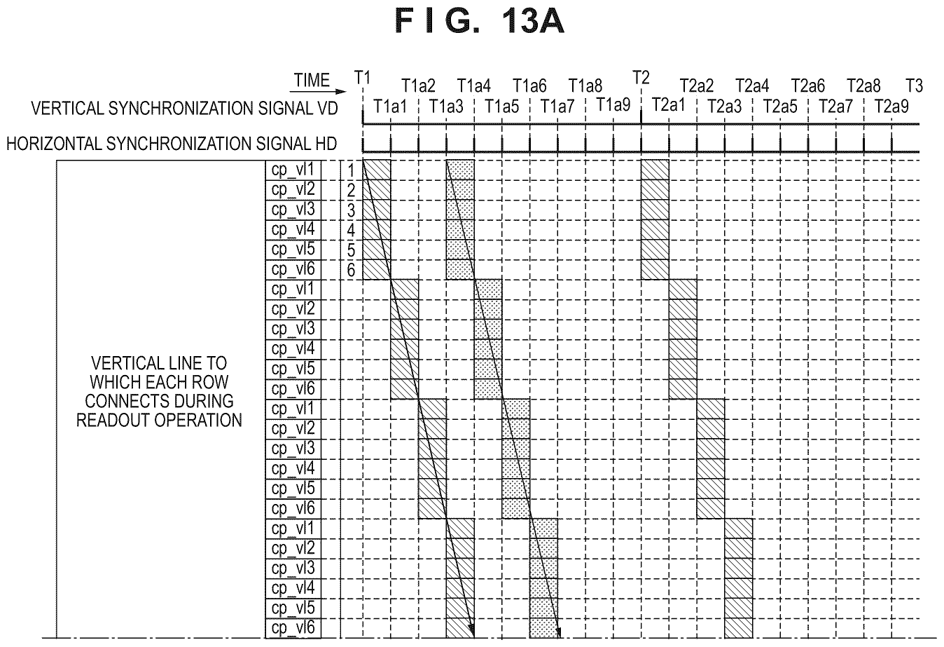

FIG. 12 is a schematic view showing an example of the arrangement of the photoelectric conversion unit 101 in this embodiment. The photoelectric conversion unit 101 includes the pixels 102. The photoelectric conversion unit 101 also includes the vertical output lines 111 connected to the pixels 102 arranged in each column. The selection transistor M4 arranged in the pixel 102(P(m, n)) in the mth column and the nth row and the vertical output line 111 are connected via a signal line sel1(n)_m, and the selection transistor M5 arranged in the pixel 102(P(m, n)) and the vertical output line 111 are connected via a signal line sel2(n)_m. The vertical output lines 111 are connected to the power supply unit 109. The vertical output lines 111 are also connected to the AD conversion unit 105.

In this embodiment, six vertical output lines 111 are arranged for each column. In the arrangement shown in FIG. 12, six vertical output lines 111 connected to the pixels in the first column are referred to as vertical output lines cl_vl #(#=1 to 6), and six vertical output lines 111 connected to the pixels in the mth column are referred to as vertical output lines cm_vl #. The signal line sel1(n)_m in each row and the vertical output line cm_vl #(#=1 to 6) are connected as follows.

The signal sel1(1)_k of the pixel 102(P(k, 1)) in the first row is connected to the vertical output line ck_vl1 (k=1 to m). The signal sel1(2)_k of the pixel 102(P(k, 2)) in the second row is connected to the vertical output line ck_vl2 (k=1 to m). The signal sel1(3)_k of the pixel 102(P(k, 3)) in the third row is connected to the vertical output line ck_vl3 (k=1 to m). Similarly, the signal line sel1(n)_m is connected to the vertical output line 111 at a period of six rows. In this connection, the vertical output lines 111 do not necessarily have to be connected to the vertical output lines ck_vl1, ck_vl2, ck_vl3, ck_vl4, ck_vl5, and ck_vl6 (k=1 to m) in row order. It is sufficient that each of ck_vl1 to ck_vl6 must be used once in six consecutive rows.

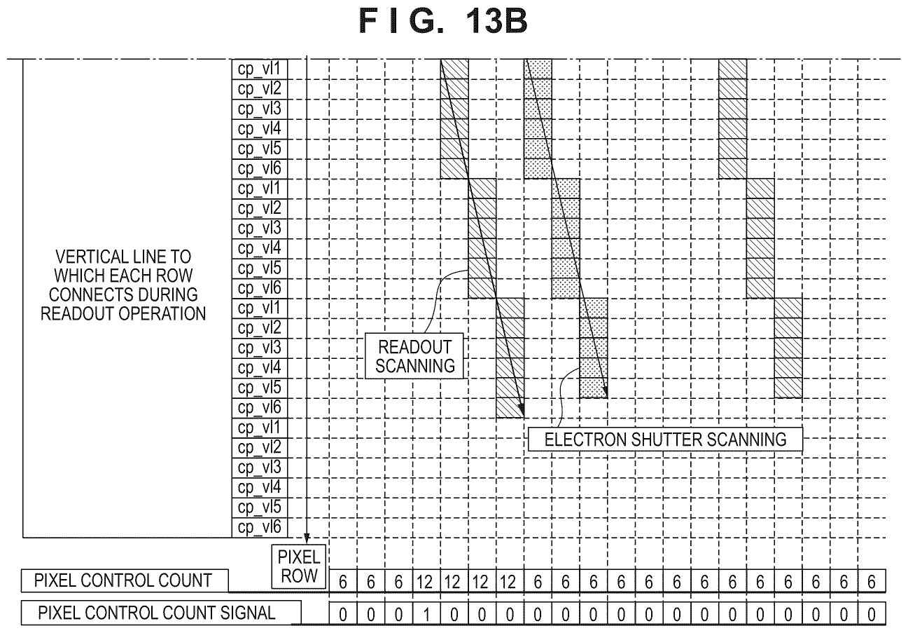

FIGS. 13A and 13B are timing charts showing an example of the vertical scanning operation of the photoelectric conversion device 100 in this embodiment. First, pixel control of the photoelectric conversion device 100 will be described. Pixel control includes electron shutter scanning and readout scanning as described above. In this embodiment, pixel signals of the pixels 102 from the first row to the Nth row (N is a natural number) are acquired by pixel control. In this embodiment, the photoelectric conversion device 100 in which six vertical output lines 111 are arranged for each column will be described as an example.

When releasing the reset of the photoelectric conversion element PD by electron shutter scanning, the transfer transistor M1 of the pixel 102 is used. The vertical scanning unit 103 controls the transfer transistor M1 via the signal PTX. When acquiring a pixel signal by readout scanning, only the selection transistor M4 arranged in the pixel 102 is used. Pixel signals are read out via six vertical output lines 111 (vertical output lines cp_vl1, cp_vl2, cp_vl3, cp_vl4, cp_vl5, and cp_vl6) arranged in each column. The first frame (from time T1 to time T2) shows an example in which each of electron shutter scanning and readout scanning is performed once.

At time T1, a readout operation is started. From time T1 to time T1a1, charges in the FDs of the pixels 102 in six rows from the first row to the sixth row are read out. At this time, the vertical scanning unit 103 controls the selection transistor M4 by using the signal PSEL1(k) (k=1 to 6) to read out the pixel signal via the selection transistor M4 arranged in the pixel 102. The pixel signal of the pixel 102 arranged in the first row is read out via the vertical output line cp_vl1, the pixel signal of the pixel 102 arranged in the second row is read out via the vertical output line cp_vl2, the pixel signal of the pixel 102 arranged in the third row is read out via the vertical output line cp_vl3, the pixel signal of the pixel 102 arranged in the fourth row is read out via the vertical output line cp_vl4, the pixel signal of the pixel 102 arranged in the fifth row is read out via the vertical output line cp_vl5, and the pixel signal of the pixel 102 arranged in the sixth row is read out via the vertical output line cp_vl6.

From time T1a1 to time T1a2, charges in the FDs of the pixels 102 in six rows from the seventh row to the twelfth row are read out. At this time, the vertical scanning unit 103 controls the selection transistor M4 by using the signal PSEL1(k) (k=7 to 12) to read out the pixel signal via the selection transistor M4 arranged in the pixel 102. The pixel signal of the pixel 102 arranged in the seventh row is read out via the vertical output line cp_vl1, the pixel signal of the pixel 102 arranged in the eighth row is read out via the vertical output line cp_vl2, the pixel signal of the pixel 102 arranged in the ninth row is read out via the vertical output line cp_vl3, the pixel signal of the pixel 102 arranged in the tenth row is read out via the vertical output line cp_vl4, the pixel signal of the pixel 102 arranged in the eleventh row is read out via the vertical output line cp_vl5, and the pixel signal of the pixel 102 arranged in the twelfth row is read out via the vertical output line cp_vl6. Subsequently, readout scanning for six rows is sequentially performed in synchronization with a horizontal synchronization signal HD shown in FIGS. 13A and 13B.

Furthermore, in the first frame (time T1 to time T2), electron shutter scanning corresponding to readout scanning in the second frame (time T2 to time T3) is performed. Electron shutter scanning is started at time T1a3. From time T1a3 to time T1a4, the reset of the photoelectric conversion element PD of each pixel 102 in six rows from the first row to the sixth row is released. Subsequently, electron shutter scanning for six rows is sequentially performed in synchronization with the horizontal synchronization signal HD. The second frame (time T2 to time T3) shows an example in which only readout scanning is executed.

The pixel control count shown in FIGS. 13A and 13B indicate the sum of the number of pixel rows undergoing electron shutter scanning and the number of pixel rows undergoing readout scanning in each period from time T1 to time T2. In each period from time T1a3 to time T1a7, electron shutter scanning and readout scanning are performed in an overlapping period, so that the pixel control count changes from the other periods. Accordingly, the power supply voltage of the photoelectric conversion device 100 fluctuates, and this causes a pixel control step in an image using the obtained image data. To suppress the pixel control step, the above-described detection unit 107 may change the level of the selection signal from level 0 to level 1 if the number of the pixels 102 driven by the vertical scanning unit 103 (driving circuit) among the plurality of pixels 102 has changed. The detection unit 107 sets the level of the selection signal to level 1 during the period from time T1a3 to time T1a4 during which the pixel control count changes. For example, in addition to the setting signal, the control unit 104 that controls the operation of the vertical scanning unit 103 may supply information of the pixel control count (the pixel control count signal shown in FIGS. 13A and 13B) to the detection unit 107, and the detection unit 107 may change the level of the selection signal in accordance with the pixel control count signal. The pixel control count signal may be supplied from the vertical scanning unit 103 to the detection unit 107. Alternatively, for example, the control unit 104 may supply the selection signal to the generation circuit 501 in accordance with the pixel control count. In this case, the circuit configuration of the control unit 104 for supplying the selection signal in accordance with the pixel control count is included in the above-described correction unit 150.

In this embodiment, the start times of readout scanning and electron shutter scanning are shown as time T1a1 to time T1a3, but each pixel control can be started at an arbitrary time. In accordance with the scanning start time of each pixel control, the position of the pixel row in the period during which electron shutter scanning and readout scanning overlap can change.

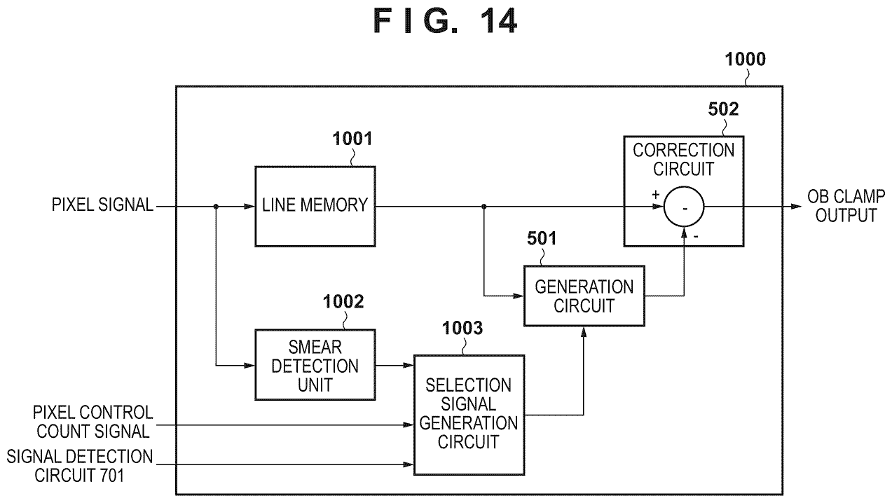

FIG. 14 is a block diagram of an OB clamp process unit 1000 in this embodiment, that is configured to achieve all of horizontal smear correction, pixel control step correction, and the above-described horizontal stripe noise correction. The OB clamp process unit 1000 includes, in addition to the arrangement of the OB clamp process unit 500 described above, a line memory 1001, a smear detection unit 1002, and a selection signal generation circuit 1003.

The line memory 1001 is a memory for storing signals output from the plurality of pixels 102 arranged in the photoelectric conversion unit 101. The line memory 1001 holds pixel signals for at least one row input to the OB clamp process unit 1000.

The smear detection unit 1002 detects, from pixel signals input to the OB clamp process unit 1000, an event that can cause a horizontal band. For example, in a CMOS image sensor, a phenomenon is known in which, when strong light strikes the light receiving region 201, signal levels of both the light receiving region 201 and the HOB region 204 float, and this generates a horizontal band. This phenomenon is referred to as horizontal smear.

The selection signal generation circuit 1003 includes the function of the selection signal generation circuit 702 arranged in the above-described detection unit 107. Therefore, in the photoelectric conversion device 100 in which the OB clamp process unit 1000 is arranged, the detection unit 107 includes the signal detection circuit 701 but the selection signal generation circuit 702 can be omitted. A signal from the signal detection circuit 701, the above-described pixel control count signal, and a horizontal smear signal from the smear detection unit 1002 are supplied to the selection signal generation circuit 1003. If a change of the state of the photoelectric conversion system is detected, the selection signal generation circuit 1003 changes the level of the selection signal from level 0 to level 1 in accordance with the signal supplied from the signal detection circuit 701. With this, horizontal stripe noise is suppressed. In addition, if the number of the pixels 102 driven by the vertical scanning unit 103 (driving circuit) has changed, the selection signal generation circuit 1003 changes the level of the selection signal from level 0 to level 1 in accordance with the pixel control count signal. With this, a pixel control step is suppressed. Furthermore, if a smear (horizontal smear) has occurred, the selection signal generation circuit 1003 changes the level of the selection signal from level 0 to level 1 in accordance with the horizontal smear signal supplied from the smear detection unit 1002. With this, a horizontal smear is suppressed.

The generation circuit 501 generates correction data (clamp value) by using the setting corresponding to the selection signal supplied from the selection signal generation circuit 1003 and the average value of light shielded signals supplied from the line memory 1001. The correction circuit 502 corrects the pixel signal of the pixel 102 arranged in the light receiving region 201, which is supplied from the line memory 1001, in accordance with the correction value generated by the generation circuit 501.

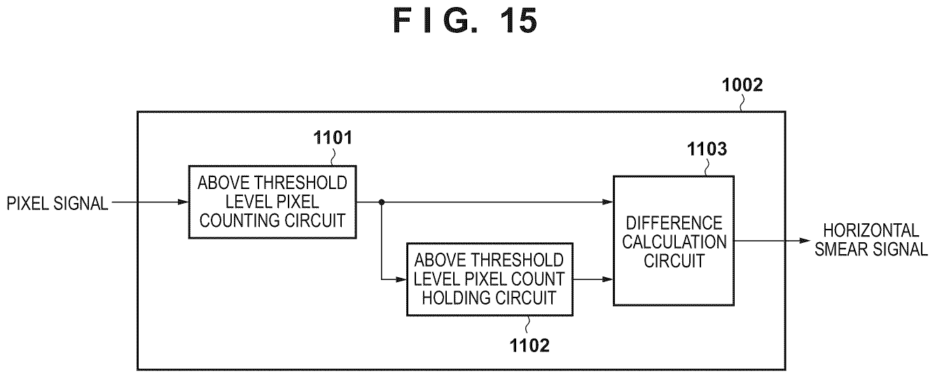

FIG. 15 is a block diagram of the smear detection unit 1002 arranged in the OB clamp process unit 1000. The smear detection unit 1002 includes an above threshold level pixel counting circuit 1101, an above threshold level pixel count holding circuit 1102, and a difference calculation circuit 1103. The smear detection unit 1002 counts the pixel 102 that has output a signal value above a threshold among the pixel signals, calculates the count value differences from the previous and next pixel rows, and outputs a horizontal smear signal.

The above threshold level pixel counting circuit 1101 counts the pixel 102 having a signal value above a threshold from the pixel signals of the pixels 102 arranged in the light receiving region 201. The above threshold level pixel count holding circuit 1102 holds the number of the pixels 102 each having the signal value above the threshold. The difference calculation circuit 1103 calculates the difference between the number of pixels each having a signal value above the threshold in the previous row and the number of pixels each having a signal value above the threshold in the current row. If the number of pixels each having a signal value above the threshold in the current row is larger than in the previous row by more than a set number, the difference calculation circuit 1103 determines that a horizontal smear has occurred. If the number of pixels each having a signal value above the threshold in the current row is smaller than in the previous row by less than the set number, the difference calculation circuit 1103 determines that a horizontal smear has disappeared. At the timing when the horizontal smear occurs or disappears, the difference calculation circuit 1103 changes the level of the horizontal smear signal. In accordance with the signal level of the horizontal smear signal, in the period during which occurrence of the horizontal smear is detected, the selection signal generation circuit changes the level of the selection signal from level 0 to level 1. This enables correction for suppressing the influence of a horizontal smear from the pixel signals.

As described above, the OB clamp process unit 1000 includes the line memory 1001, the smear detection unit 1002, and the selection signal generation circuit 1003 in addition to the arrangement of the OB clamp process unit 500 described above. However, the selection signal generation circuit 1003 has an arrangement similar to that of the selection signal generation circuit 702 arranged in the above-described detection unit 107. Further, the circuit scale of each of the line memory 1001 and the smear detection unit 1002 is relatively small. That is, it is possible to achieve all of horizontal smear correction, pixel control step correction, and horizontal stripe noise correction while suppressing an increases of the circuit scale.

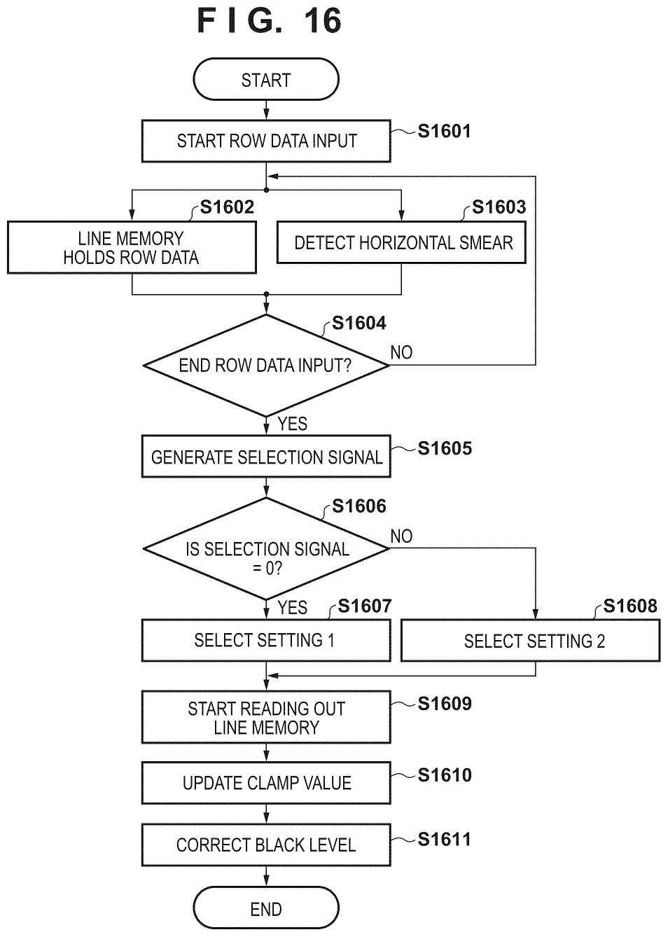

FIG. 16 is a flowchart showing the signal processing of the OB clamp process unit 1000 in this embodiment. The correction unit 150 corrects horizontal stripe noise and the like by using steps S1601 to S1611 shown in FIG. 16.

First, in step S1601, row data including pixel signals of the pixels 102 arranged in each pixel row among the plurality of pixels 102 arranged in the photoelectric conversion unit 101 is input to the line memory 1001 and the smear detection unit 1002. In step S1602, the line memory 1001 holds the row data. In step S1603 that can be performed in parallel with step S1602, a horizontal smear is detected by referring to the row data input to the smear detection unit 1002. In step S1604, it is determined if input of the row data ends. If the input ends (YES), the process advances to step S1605. If the input continues (NO), the process returns to row data input.

If the process transitions to step S1605, a selection signal is generated. As described above, three kinds of detection signals including a signal from the signal detection circuit 701 corresponding to the setting signal, a pixel control count signal, and a horizontal smear signal are supplied to the selection signal generation circuit 1003. If none of the three detection signals indicates the detection of the corresponding event, that is, if an external device is in normal operation, if the number of driven pixels does not change, or if no horizontal smear is detected, the selection signal generation circuit 1003 generates, as a selection signal, a signal at level 0. On the other hand, if any one of the three detection signals indicates the detection of the corresponding event, the selection signal generation circuit 1003 generates, as a selection signal, a signal at level 1 throughout the period during which the detection of the corresponding event is indicated.

In step S1606, the selection circuit 602 of the generation circuit 501 determines the level of the selection signal. If the selection signal is at level 0 (YES), the process transitions to step S1607, and the generation circuit 501 is set in accordance with the setting 1. For example, a correction coefficient corresponding to the setting 1 is set in the attenuation circuit 603. If the selection signal is not at level 0 (NO), the process transitions to step S1608, and the generation circuit 501 is set in accordance with the setting 2. For example, a correction coefficient corresponding to the setting 2 is set in the attenuation circuit 603.

After the generation circuit 501 is set, in step S1609, reading out of the row data held by the line memory 1001 is started. In step S1610, the readout row data (light shielded signals) is used to update the clamp value by the IIR-type LPF forming the generation circuit 501 as described above. In step S1611, the correction circuit 502 corrects, using the updated clamp value, the black level of the pixel signal acquired by the photoelectric conversion unit 101.

According to the operation described above, the photoelectric conversion device 100 (correction unit 150) according to this embodiment can correct a pixel control step and a horizontal smear in addition to a horizontal stripe noise. Here, in this embodiment, an example has been described in which a selection signal is generated by referring to three kinds of detection signals including a signal from the signal detection circuit 701 corresponding to the setting signal, a pixel control count signal, and a horizontal smear signal. However, the present invention is not limited to this, and a selection signal may be generated by referring to one or two kinds of detection signals out of three kinds of detection signals. For example, the photoelectric conversion device 100 (correction unit 150) may be configured to allow a user to freely select the detection signal to be referred to.

In the photoelectric conversion device 100 shown in FIGS. 10 to 16, by arranging the line memory 1001, the degree of freedom in correction for each pixel row can be increased. For example, with respect to the signals (row data) output from the plurality of pixels 102 in the detection period during which one of the three kinds of detection signal indicates the detection of the corresponding event and in at least one of a predetermined period before the detection period and a predetermined period after the detection period, the selection signal at level 1 may be supplied and the setting corresponding to the setting 2 may be used to generate a clamp value (correction data). Also in the procedure shown in FIG. 8, it is possible to generate a clamp value in accordance with the setting 2 and perform correction with respect to the row data output from the plurality of pixels 102 in the detection period and the period after the setting period. On the other hand, in the arrangement shown in FIGS. 10 to 16, it is possible to generate a clamp value in accordance with the setting 2 and perform correction with respect to the row data output from the plurality of pixels 102 in the detection period and the period before the setting period.

The correction unit 150 that executes the OB clamp process described in each embodiment described above may be provided in the photoelectric conversion device 100 as described above. However, the present invention is not limited to this. For example, at least some components of the correction unit 150 may be arranged separately from the photoelectric conversion device 100 or the photoelectric conversion unit 101. The correction unit 150 may be a computer such as a personal computer including a processor (for example, a CPU or an MPU) separated from the photoelectric conversion device 100. Alternatively, for example, the correction unit 150 may be a circuit such as an ASIC that implements the above-described function.

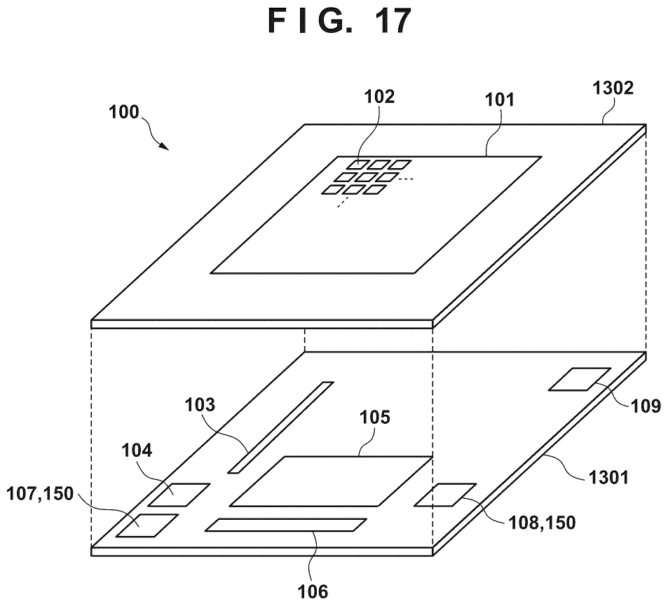

FIG. 17 is a view showing an arrangement example in a case in which respective blocks of the photoelectric conversion device 100 shown in FIG. 1 are arranged in substrates made of a semiconductor or the like. The photoelectric conversion device 100 may include a substrate 1301 and a substrate 1302 using a semiconductor such as silicon. Components such as the detection unit 107, the correction unit 150 including the signal processing unit 108, the vertical scanning unit 103, the control unit 104, the AD conversion unit 105, the horizontal scanning unit 106, the power supply unit 109, and the like may be arranged in the substrate 1301. The photoelectric conversion unit 101 is arranged in the substrate 1302. As shown in FIG. 17, the substrate 1301 and the substrate 1302 may be at least partially stacked. With this arrangement, when manufacturing the photoelectric conversion device 100, it is possible to select a process suitable for each of an analog portion including the photoelectric conversion unit 101 and a logic portion including the signal processing unit 108. By using the manufacturing processes suitable for the respective components, excellent characteristics can be obtained in the respective components included in the photoelectric conversion device 100. As a result, the photoelectric conversion device 100 with improved image quality is obtained.

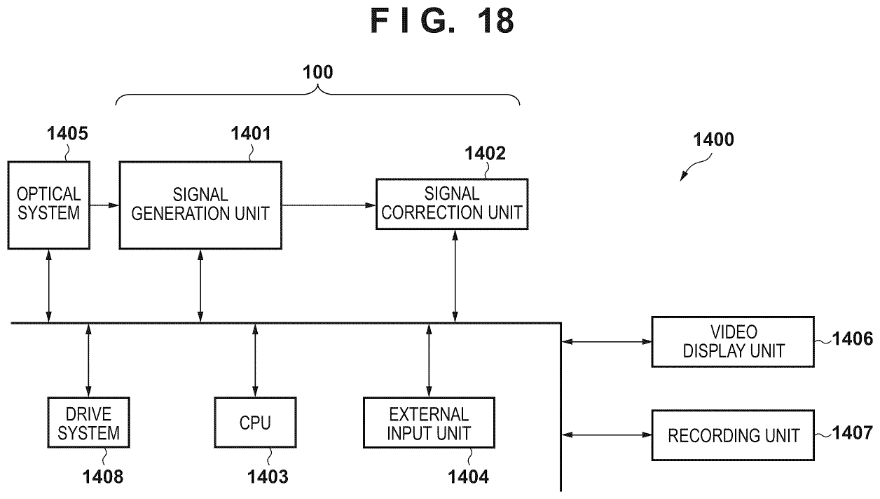

FIG. 18 shows the arrangement of an image capturing system 1400 as an example of an apparatus incorporating the above-described photoelectric conversion device 100. The image capturing system 1400 includes a signal generation unit 1401, a signal correction unit 1402, a CPU 1403, an external input unit 1404, an optical system 1405, a video display unit 1406, a recording unit 1407, and a drive system 1408.

The signal correction unit 1402 can include the above-described detection unit 107 and signal processing unit 108. The signal generation unit 1401 can include components such as the above-described vertical scanning unit 103, control unit 104, AD conversion unit 105, horizontal scanning unit 106, and power supply unit 109. Accordingly, a configuration including the signal generation unit 1401 and the signal correction unit 1402 can be the photoelectric conversion device 100 described above.

In accordance with light emitted through the optical system 1405, which is configured to make light enter the photoelectric conversion unit 101 of the signal generation unit 1401, the signal generation unit 1401 performs photoelectric conversion to generate an analog image signal, and performs AD conversion, thereby outputting image data. The output image data undergoes a correction process by the signal correction unit 1402 such that it can be output to and stored in the video display unit 1406 and the recording unit 1407. The video display unit 1406 displays an image using the display image data having undergone the correction process. The recording unit 1407 stores the display image data. The CPU 1403 controls the respective components in the image capturing system 1400 as described above. In other words, the CPU 1403 functions as a processing device that performs a process for displaying the signals output from the signal generation unit 1401 and the signal correction unit 1402, which can constitute the photoelectric conversion device 100, on the video display unit 1406, and a process for storing the signals in the recording unit 1407. The driving system 1408 is arranged to, for example, operate the focus and aperture of the optical system 1405. The external input unit 1404 can include various kinds of buttons and the like used by a user to input an image capturing condition and perform a shutter operation. A touch panel as the video display unit 1406 may be arranged, and the video display unit 1406 may function as the external input unit 1404 (a part thereof).

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-014305, filed Feb. 1, 2024, which is hereby incorporated by reference herein in its entirety.

What is claimed is:

1. A photoelectric conversion device comprising a plurality of pixels, and a correction unit configured to correct, in accordance with correction data, a black level of pixel signals output from the plurality of pixels,
wherein the correction unit is configured to:
change a level of a selection signal from a first level to a second level if a state of a photoelectric conversion system where the photoelectric conversion device is arranged changes in one frame period during which signals for generating one image are obtained; and
select a setting for generating the correction data from a plurality of settings in accordance with the level.

2. The device according to claim 1, wherein the correction unit generates, using the setting according to the level, the correction data from a signal value based on a light shielded signal output from a pixel arranged in a light shielded region among the plurality of pixels.

3. The device according to claim 2, wherein
the correction unit includes a generation circuit configured to generate the correction data, and a correction circuit configured to correct the pixel signal in accordance with the correction data,
the generation circuit includes a low-pass filter connected to an input node of the signal value, and
the setting is a setting of an amount of attenuation of the low-pass filter.

4. The device according to claim 3, wherein a tracking ability of the low-pass filter set in accordance with the second level is higher than a tracking ability of the low-pass filter set in accordance with the first level.

5. The device according to claim 3, wherein the correction unit generates the correction data by using one of an inter-pixel smoothing process and an inter-row smoothing process.

6. The device according to claim 1, wherein
the correction unit includes a detector configured to detect a change of the state and generate the selection signal, and
the detector sets the level to the second level over a detection period during which a change of the state is detected.

7. The device according to claim 6, wherein
the correction unit
includes a memory configured to store signals output from the plurality of pixels, and
generates the correction data by using a setting according to the second level with respect to signals output from the plurality of pixels in a detection period during which the detector detects a change of the state and in at least one of a predetermined period before the detection period and a predetermined period after the detection period.

8. The device according to claim 6, wherein in at least one of a case where communication is being performed between the photoelectric conversion device and a device in the photoelectric conversion system other than the photoelectric conversion device and a case where a motor of a device in the photoelectric conversion system other than the photoelectric conversion device is being driven, the detector changes the level to the second level.

9. The device according to claim 6, wherein a signal indicating a change of the state is supplied from a control circuit of the photoelectric conversion system to the detector.

10. The device according to claim 1, wherein a signal at the second level includes signals at a plurality of levels in accordance with a change of the state.

11. The device according to claim 1, wherein if the state is a predetermined state, the correction unit keeps the level to the first level regardless of a change of the state.

12. The device according to claim 11, wherein the predetermined state includes a state in which a sensitivity of the photoelectric conversion system is set to not less than a predetermined sensitivity.

13. The device according to claim 1, wherein if a power supply voltage of the device fluctuates, the correction unit changes the level from the first level to the second level.

14. The device according to claim 13, wherein if a cyclic change of a value obtained by analog-digital conversion of the power supply voltage at a predetermined cycle exceeds a threshold, the correction unit changes the level to the second level.

15. The device according to claim 1, further comprising a driving circuit configured to drive the plurality of pixels,
wherein if the number of pixels driven by the driving circuit among the plurality of pixels changes, the correction unit changes the level from the first level to the second level.

16. The device according to claim 1, wherein if a smear occurs, the correction unit changes the level from the first level to the second level.

17. A photoelectric conversion device comprising a plurality of pixels, and a signal processor configured to correct a black level of pixel signals output from the plurality of pixels in accordance with correction data,
further comprising a detector configured to detect a fluctuation of a power supply voltage of the device and generate a selection signal,
wherein if a fluctuation of the power supply voltage is detected, the detector changes a level of the selection signal from a first level to a second level, and
the signal processor is configured to select a setting for generating the correction data from a plurality of settings in accordance with the level.

18. An apparatus comprising:
the photoelectric conversion device according to claim 1; and
a processing device configured to process a signal output from the photoelectric conversion device.
